(19) United States
(12) Patent Application Publication
(10) Pub. No.: US 2003/0236821 A1
(43) Pub. Date: Dec. 25, 2003

(54) Body wearable personal network server and system

(76) Inventor: Goun-Zong Jiau, Plano, TX (US)

Correspondence Address: GOUN-ZONG JIAU, 3104 WALSINGHAM DR., PLANO, TX, 75093, US

(21) Appl. No.: 10/163,701

(22) Filed: Jun. 5, 2002

(51) Int. Cl. G06F 15/16

(52) U.S. Cl. 709/203

(57) ABSTRACT

A body wearable personal network server device has a display, function keys, alarm output indicators, a disk driver to receive and store clients' data, and communication devices to communicate to its clients, such as mobile phone, personal digital assistant (PDA), personal computer, and notebook computer. A body wearable personal network device also contains software modules; such as a protocol handler to handle Internet based protocols XML/FTP/HTTP/TCP/IP, diagnostic system to automatically transmit of notification messages to its clients, and various applications to provide various services for its clients. A body wearable personal network device has gate way functionality between PAN (using Bluetooth) and WLAN (using IEEE802.11b).

### BACKGROUND OF INVENTION

1. Field of the Invention

The present invention relates a server-client model of data collection and internetworking gate way system, typically including a hardware device and software modules providing application and database server capabilities, and gate way functionality between Personal Area Network (PAN) and Wireless Local Area Network (WLAN), wherein the system is to be worn by the system operator, and capable for storing and retrieving data for its clients under Internet based protocols over a Personal Area Network, and capable internetworking between PAN and WLAN.

2. Description of the Background Art

Recently, it is convenient to get information from the Internet through the personal communicators, such as mobile phone, personal digital assistant (PDA), personal computer, packet personal computer, and notebook computer. Usually, this information is stored into the storage device of the personal communicators for further using, but the storage space is always not enough to keep Internet information for long term. If try to increase the storage space, need to enlarge equipment size, and need to increase the power supply also the weight will be increased.

The personal communicators are popular and always come out a new model frequently. A user may purchase the new model to replace the old one. Once the new model is activated, data in the old model needs to be copied to the new model then the memory device in the old model will be thrown. It is inconvenient and costly for the old memory device may be still functional, does not need to be obsolete with the old model at same time.

Recently, the battery usage time for the personal communicators is not long enough. A user needs to recharge the battery frequently.

Recently, the mobile phone devices enable the users to play Internet games or watch movie via the Internet, but it is expensive for on line usage due to the Internet payment, and at the same time the phone channel is occupied that prohibits the users from making or receiving any phone calls.

Recently, it is expensive for wireless Internet services through mobile phone or PAD.

Recently, Mobile phone or PDA can not provide both connections to PAN; such as Bluetooth, and WLAN; such as IEEE802.11b.

### SUMMARY OF INVENTION

The present invention is able to store data, which is downloaded from the Internet web servers via the personal communicators. The present invention is body wearable, so the individual can retrieve data from the invention anywhere, anytime, and the access of the Internet is thus unnecessary.

The present invention is not anymore a server-client coexistent device. The present invention separates a conventional data communicator device into a server and a client. The server is body wearable and has its own battery and memory. The client is conventional personal communicator therefore can be redesigned to decrease its weight by decreasing its memory spaces or battery size.

The present invention can be set as the distributed database of its clients. The identical data does not put in all clients anymore. The data will be easy to maintain.

When any of old client needs to be replaced, the present invention needs not to be replaced with the client, so the data in the present invention will not be changed. The cost of replacing one of old clients is lower than to replace the server-client coexistent device.

The multiple users can simultaneously interactive to the present invention for playing game or watching movies. In the meantime, the phone channel is still available to allow the user to access phone calls.

The various kinds of applications can be installed in the present invention to provide the user convenient tools for managing his or her data.

The present invention is designed based on Internet protocols, so there is no need for extra conversion for the data, which is used in the Internet web server and tried to store in the present invention.

The present invention can be designed as an XML application server to provide the maximum coverage and is easy to maintain in the long run. The server programming gives the most control.

The present invention can provide gate way functionality for transmitting data between PAN and WLAN networks.

### BRIEF DESCRIPTION OF DRAWINGS

FIG. 1A shows a general picture of a body wearable personal network server and system according to the present invention.

FIG. 1B is a block diagram corresponding to the entities in FIG. 1A to illustrate the relationship of server and clients, also illustrates the blocks for representing the area of the invention that is applied. The present invention comprises the software and hardware portions in a body wearable personal network server and the software for personal communicators to enable it to work with the body wearable personal network server.

FIG. 1C shows a internetworking picture among the present invention, Personal Area Network, and Wireless Local Area Network.

FIG. 2A shows an external appearance of a body wearable personal network server (device).

FIG. 2B is a perspective view of the batteries location in a body wearable personal network server (device).

FIG. 2C is a view of bottom up aspect of a body wearable personal network server (device).

FIG. 2D is a view of the location of the rechargeable power supply contacts, the location of Universal Serial Bus (USB) connector, and the location of the alarm apparatus. The device also provides a vibrated gear inside the body wearable personal network server (device).

FIG. 3A is a block diagram illustrating the components of the hardware portion in a body wearable personal network server in FIG. 1B.

FIG. 3B is a block diagram illustrating the components of the communication portion in FIG. 3A.

FIG. 3C is a block diagram illustrating the components of the output devices in FIG. 3A.

FIG. 4A is a block diagram illustrating the components of the software portion in a body wearable personal network server in FIG. 1B.

FIG. 4B is a block diagram illustrating some of applications can be installed in the body wearable personal network server.

FIG. 4C is a block diagram illustrating the types of the data formats that can be provided in the body wearable person network server.

FIG. 5 is a block diagram illustrating the functions of the software portion in the body wearable personal network server in FIG. 4A.

FIGS. 6A, 6B, and 6C is a flow chart illustrating the manner in which the operating management functions and applications are performed in the body wearable personal network server.

FIG. 7A is a block diagram illustrating the components of the software portion in the personal communicators in FIG. 1A.

FIG. 7B is a block diagram illustrating how the identical application software can be Installed in the different personal communicators based on the different platforms, which provides different APIs for the application software.

FIG. 8 is a block diagram illustrating the functions of the software portion in the personal communicators in FIG. 7A.

FIG. 9A is a flow chart illustrating the software portion in the personal communicators to perform the manner of the outgoing signal to the body wearable personal network server.

FIG. 9B is a block diagram illustrating the various sources that generate the outgoing signal from the personal communicators.

FIGS. 10A, 10B, and 10C is a flow chart illustrating the software part in the personal communicators to perform the manner of the incoming signal from the body wearable personal network server.

FIG. 11 shows a picture of a body wearable personal network server and system, which provides access authorities for the multiple users.

### DETAILED DESCRIPTION

Embodiments of the present invention are hereinafter described in conjunction with the drawings.

First Embodiment.

A first embodiment is discussed now.

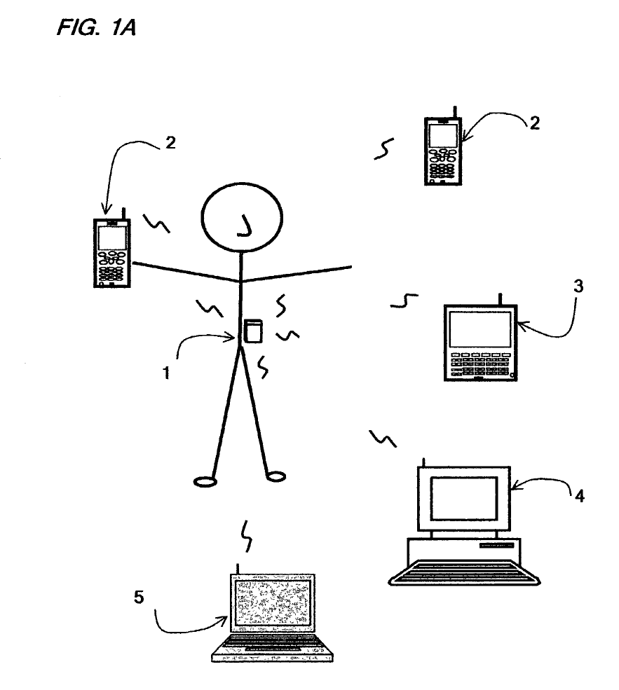

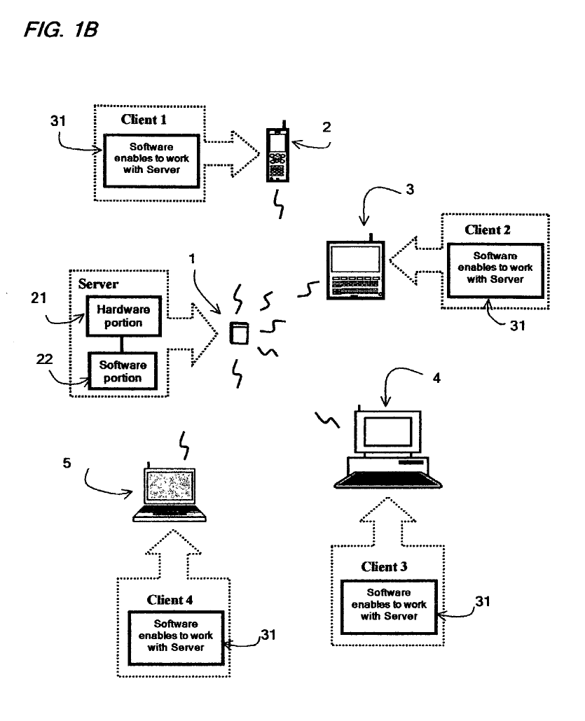

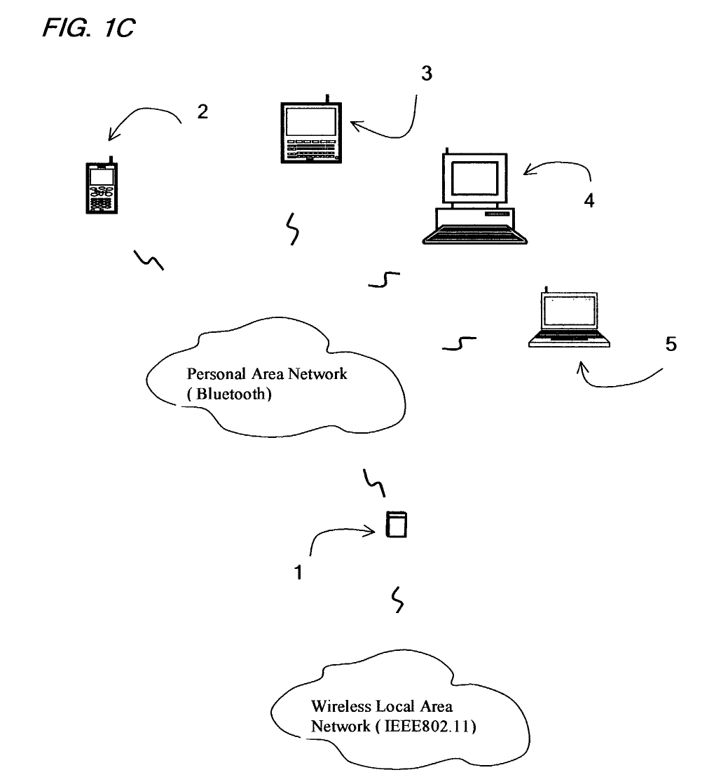

FIG. 1A illustrates the general working environment of the present invention where it is applied. The device of the present invention denoted as 1 is a body wearable device, and is able to communicate with personal communicators, such as mobile phone denoted as 2, PDA denoted as 3, personal computer denoted as 4, and notebook computer denoted as 5, via a wireless connection; such as a PC card (formerly known as PCMCIA card—The Personal Computer Memory Card International Association) providing IEEE 802.11 or Bluetooth protocol in a PC card slot, or/and a wire connection through USB connector. In order to achieve the functions of the present invention, the proper software needs to be installed in the device of the present invention 1, and in the personal communicators 2, 3, 4, and 5.

The body wearable personal network device portion is acting as a sever 1 in FIG. 1B, and the personal communicators are acting as clients 2, 3, 4, and 5 in FIG. 1B. The relationship of server and clients for the present invention is illustrating in FIG. 1B. FIG. 1B is a schematic block diagram to illustrate the present invention, which is a body wearable personal network sever and system. The system includes a body wearable personal network server (BWPNS) 1 with its hardware portion 21 and software portion 22, and the software portion 31 is installed in personal communicators in order to enable personal communicators to work with the BWPNS.

A procedure to activate the clients (personal communicators) in order to work with the server (BWPNS) is first to configure one of the clients as an administrator, which needs to be set up by the server 1, and the rest of the clients will be configured by the administrator. After activation, all clients need to register to server to provide its resource profile; such as the size of its screen, then the server will provide unique identification for each client. The server 1 holds all resource profiles and identifications in database. As soon as a client is authorized to access the server, it can download and upload the data from and to the server. The communication protocols between server and clients adopt the standard Internet protocol stack, such as XML (extensible Markup Language), WML (Wireless Markup Language), or FTP (File Transfer Protocol) above HTTP (Hypertext Transfer Protocol), and each virtual IP address for each client can be configured by administrator and managed by the server.

FIG. 1C shows that the BWPNS denoted as 1 provides the gate way functionality between PAN (through protocol; such as Bluetooth), and WLAN (through protocol; such as IEEE802.11b).

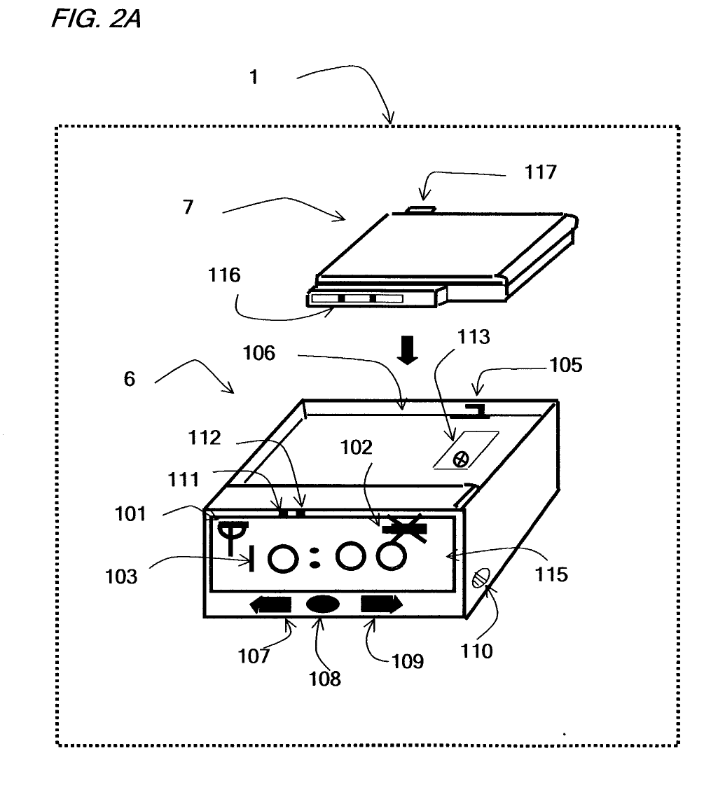

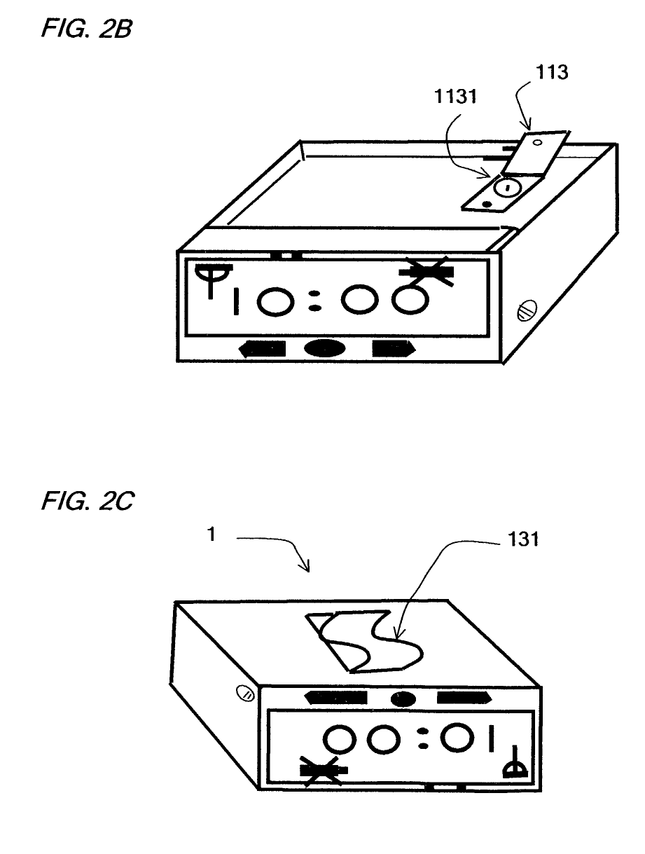

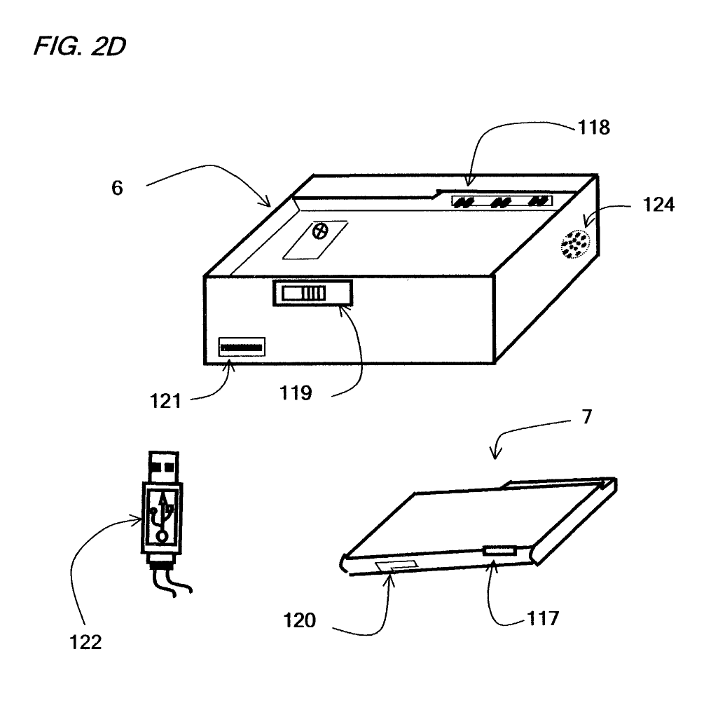

FIG. 2A is the general outlook of the BWPNS device denoted as 1 in FIG. 1A, which comprises a body case denoted as 6, and a removable/rechargeable battery denoted as 7. The body case6 comprises the wireless connection status icon denoted as 101. When this icon appears on the liquid Crystal Display (LCD) denoted as 115, it means that there is at least one of the registered clients communicating to the server. Another icon denoted as 102 is an indicator of the strength of the power supply. The timer denoted as 103 can be shown on LCD as the default screen. Function keys denoted as 107, 108, and 109 are designed on the bottom of the LCD. The application programs can be designed to handle these function keys. An example like one of the applications use the function key 107 to choose the left item of the selection, the key 109 is used to choose the right item of the selection, and the key 108 is used to confirm and execute the selection. The power switch denoted as 110 handles to turn-on and turn-off the power. There are two LED (Light Emitting Diode) indicators denoted as 111, and 112, which are programmable and allow application programs to exhibit exception signs to the user. There is a lid denoted as 13. Under the lid, there is a liquid crystal battery denoted as 131 in FIG. 2B. A removable/rechargeable battery secure lock denoted as 105 is for holding the battery. The battery charge contacts denoted as 116 are used to recharge the battery power. A bulgy object denoted as 117 is used for easily pull off the battery.

As illustrated in FIG. 2C, shows a bottom up view of the BWPNS device, which can be hanged on waist belt by a clip denoted as 131

As illustrated in FIG. 2D, the BWPNS device is designed for providing wire and wireless connections. The wire connection is the USB type of adaptor denoted as 121, which is able to connect to a client via USB cable denoted as 122. The wireless connection use a Bluetooth plus IEEE802.11b card build inside device 6, which can adopt dual-mode Bluetooth and IEEE802.11b in the same device; such as Blue802 Technology unveiled by Intersil and Silicon Wave. Contact information is Silicon Wave, Inc. 6256 Greenwich Drive Suite 400, San Diego, Calif. 92122 and Intersil Corporation, 7585 Irvine Center Drive Suite 100, Irvine, Calif. 92618. A battery release button denoted as 119 to release the removable battery, which is locked through the notch denoted as 120. The power supply contacts denoted as 118. The speaker apparatus denoted as 124, which is programmable and allows application programs to use it to generate basic radio alarms.

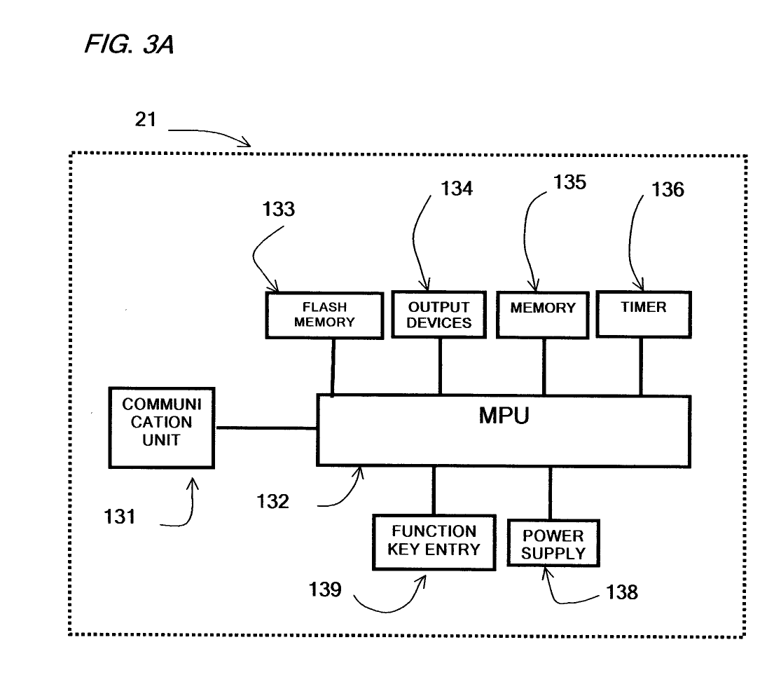

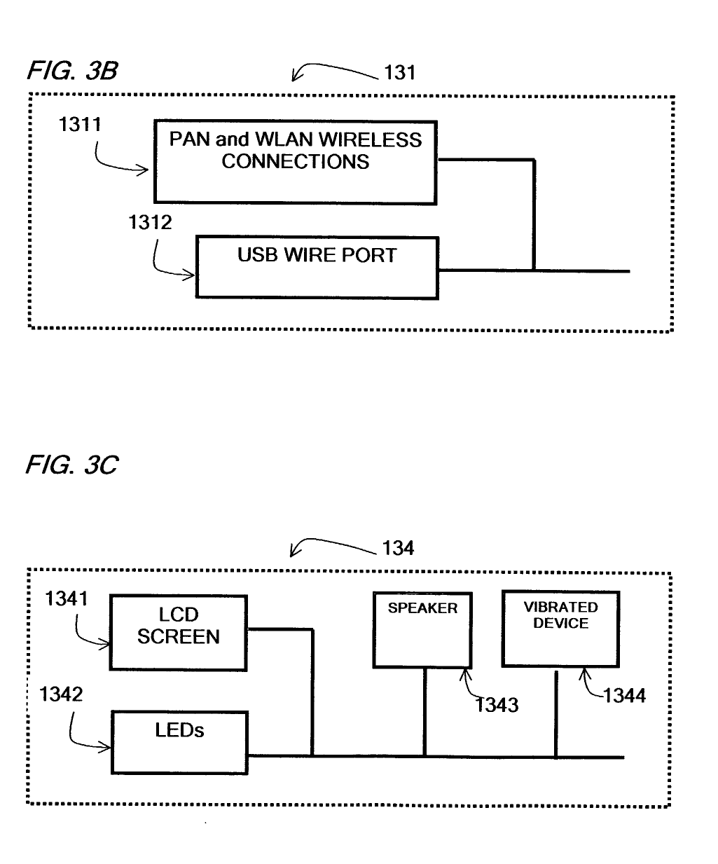

A block diagram FIG. 3A illustrates the primary components to comprise the BWPNS hardware portion 21 of the server 1 in FIG. 1B. The components include MPU (MicroProcessor Unit) 132, power supply138, ROM and RAM memory 135, output devices 134, Flash Memory Chips; (Disk-on-Chips) 133, the communication units 131, function key entry 139, and a timer 136. The communication units illustrated in FIG. 3B include wireless connection 1311, providing dual radio modes of PAN (such as Bluetooth) plus WLAN (such as IEEE 802.11b) via a PC card or build-in device, and USB wire communication port 1312. The output devices illustrated in FIG. 3C include a LCD 1341, indication LEDs 1342, a speaker 1343, and a vibrated device 1344.

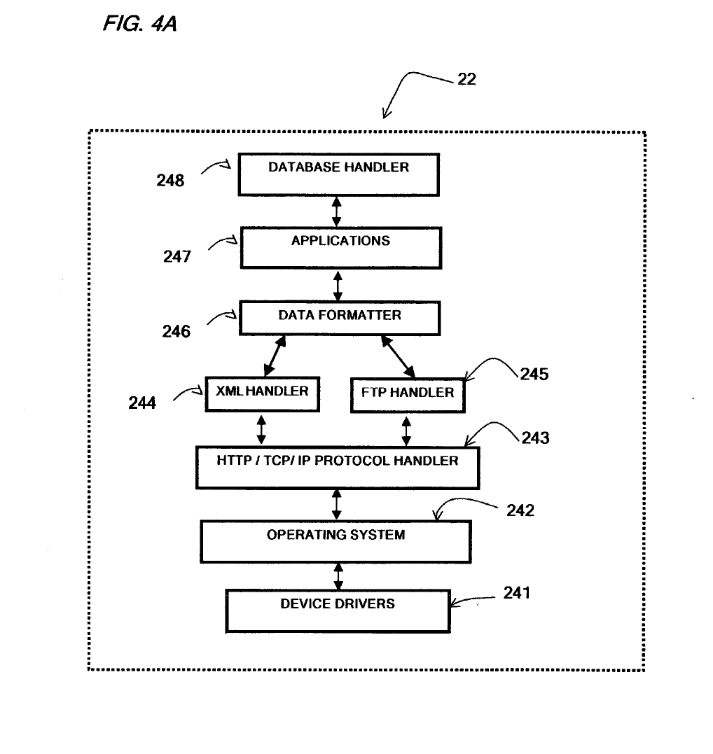

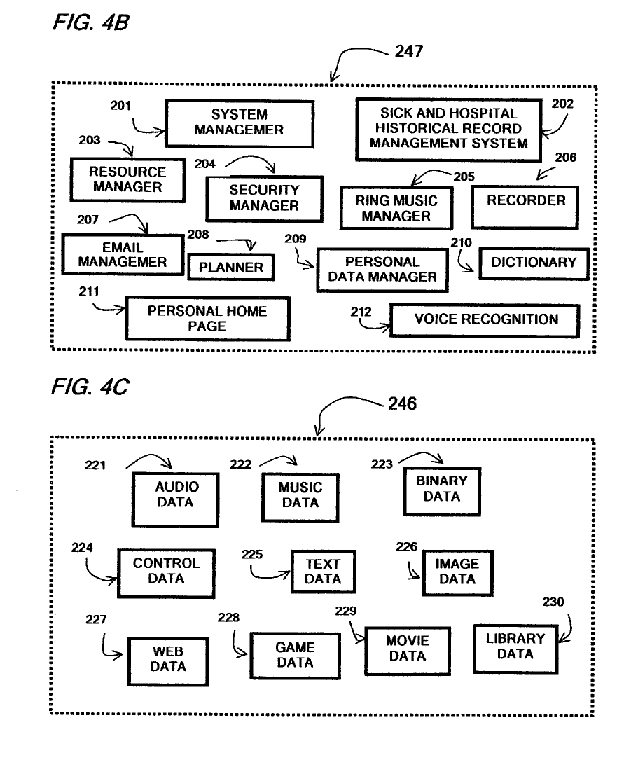

A block diagram FIG. 4A illustrates the software hierarchical structure for software portion 22 in FIG. 1B in the BWPNS denoted as 1 in FIG. 1B. The device drivers 241 interface with hardware devices and provide the upper level the software channels to use hardware devices, such as to access hard disk driver for retrieving or storing data files. An operating system (OS) 242 is a brain of the software portion, which handles and manages system resources, schedules application tasks, manages memory allocation, handles system exceptions, and so on. The HTTP/TCP/IP/Data Link/Physical Layer protocol handler 243 performs all protocol issues according to protocol agreements published by the standard organizations; such as ITU or IETF. Based on the customer's requirements, profiles or the incoming event type, the XML (Extensible Markup Language) handler 244 or FTP (File Transfer Protocol) handler 245 is evoked for receiving or sending the proper types of presentations. The data formatter 246 is the extension of the applications, which convert data into proper format according to users' profiles. As FIG. 4C, the generated data formats that the BWPNS supports are audio data 221, such as wav files, music data 222, such asmp3 files, binary data 223, control data 224, which is under the control command format using between server and clients, text data 225, image data 226, such as JEPG, web data 227, such as WAP, XML files, game data 228, movie data 229, such as mpeg files, and library data 230, such as dll files.

Continue in FIG. 4A, the applications 247 installed in the BWPNS provide the services to the clients. As FIG. 4B, the applications include:

System Manager 201: This application is running in the background and attempt to detect any exceptions of the system (BWPNS). A warning sign or report will be generated whenever any exception is detected.

Personal sick or hospital historical record management system 202: This system manages the personal healthy records for routine or emergent purposes.

Resource Manager 203: This application is running in the background and attempts to manage the resources for the BWPNS. An example is when after a long run, the hard disk space contains too many fragmental spaces, so this application will be automatically executed to de-fragmentize the spaces.

Security Manager 204: This application handles all security issues; such as assigns the access authorities to clients, and attempts to block hikers to break into the system.

Ring Music Manager 205: This application assigns the user configured music to use for ring sound.

Recorder 206: This application allows the user to use the BWPNS as a voice recorder. The voice can be put from client, and can be played to clients.

Email manager 207: This application stores, retrieves, and manages the emails for the user. It also provides the ability to convert the text data format to the voice data format, and vice visa.

Planner 208: The application can accept the schedule plans from user for monitoring and arrangement the schedules. It also generates an alarm or a report to the user when the schedule time is reached.

Personal data manager 209: This application is designed to help user to store, retrieve, and manage his or her personal data, such as a phone list, a shopping list, and personal photos.

Dictionary 210: This application can be a dictionary for the user; such as it can be an English dictionary and can travel with the user.

Personal Home Page 211: The user can configure, store, and retrieve his or her home page in BWPNS through this application. The personal Home Page then can be shown on his or her personal communicators.

Voice Recognition 212: This application can accept voice commands and provides proper responses to the user.

The database handler 248, such as Microsoft SQL2000, which provides capabilities to manage, store and retrieve data in the databases.

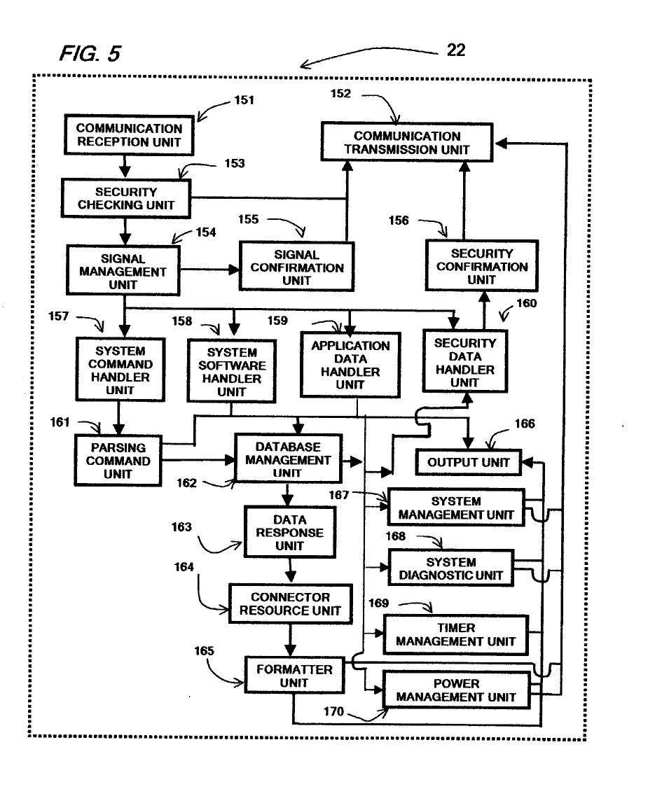

FIG. 5 is a data flow diagram that illustrates the software portion 22 in FIG. 1B in the BWPNS denoted as 1 in FIG. 1B. The communication reception unit 151 receives an event sent from a client (a personal communicator), or from the function key touch pad on the BWPNS. The communication reception unit forwards the event to the security-checking unit 153 for the security and authorization checking. If the incoming event does not pass the security checking, a failure indication signal will be sent back to the event generator via the communication transmission unit 152. If the incoming event passes the checking, the event is sent to the signal management unit 154 for distinguishing the type of the event in order to determine the further direction of the event. If the event is sent from the personal communicator, the signal confirmation unit 155 will be evoked to send a confirmation message back to the personal communicator via the communication transmission unit 152, otherwise based on the event type, a proper event handler unit is evoked to handle the incoming event. The general event handlers are: System Command Handler Unit (SCHU) 157: Some of events are for control commands, which are used to control, manage, or synchronize the in progressing communication activities between the server (BWPNS), and clients (Personal Communicators); such as hand sharking activity.

System Software Handler Unit (SSHU) 158: SSHU is for installing or updating the system software. The system software is for managing, handling, and maintaining the hardware devices, and software resources.

Application Data Handler Unit (ADHU) 159: ADHU is for applications to handle, store, and retrieve any format of data, as well as converting text format of data to voice format of data or voce visa.

Security Data Handler Unit (SDHU) 160: SDHU is for administrator to handle security events.

The Command Parsing Unit 161 is evoked by the SCHU 157 to parse the system command signals. Based on applications, some of system commands will be sent to the Database Management Unit 162 to interact with database, and some of system commands directly issue results to the Output Unit 166.

The Database Management Unit 162 is for storing, retrieving, controlling, and managing the database. Based on the different characters of data and programs, the resources of the data storage need to be managed, and the theory and the method to access the data storage need to be controlled by the Database Management Unit 162.

If incoming command asks for or the internal application is evoked for response of the result, the result will be retrieved from the Database Management Unit 162. The Data Response Unit163 will be in service to handle the outgoing data. The Connector Resource Unit 164 is also put in service to evoke the proper output devices, to check the availabilities of the resources, and to obtain the resources for this event.

Based on the command or the application, the outgoing data may need to be reformatted by the Formatter Unit 165.

Inside the BWPNS, there are some units that are automatically, periodically, or intentionally executed in the background of the system. These units are: System Management Unit (SMU) 167: SMU is evoked to issue, report, or record the system status situations. SMU sends the results to the Output Unit 166 or to the clients (Personal Communicators) via the Communication Transmission Unit 152.

System Diagnostic Unit (SDU) 168: Usually, SDU is always executed in the background. As soon as the system detects any exceptions of the system, the SDU is evoked to attempt to fix the problem and generate the reports to the Output Unit 166 or to the clients (Personal Communicators) via the Communication Transmission Unit 152.

Timer Management Unit (TMU) 169: TMU is executed in the background and can be configured by Function Keys denoted as 107, 108, and 109 in FIG. 2A. The accurate time displays on LCD denoted as 103 in FIG. 2A.

Power Management Unit (BMU) 170: BMU provides the status of the power strength. If the battery strength is very weak and needs to be recharged, the signal will be sent to the Output Unit 166, and the power strength icon denoted as 102 in FIG. 2A will show the cross mark on the icon. At the request, BMU can also display the current power strength on the LCD denoted as 103 in FIG. 2A. The BMU can be used to determine whether the server is in “sleep” or “wake up” mode. When the server is in idle for a while, BMU will leave the server in a sleep mode for power conservation, and BMU generates a “wake up” on the receiving of data.

The Output Unit 166 groups the different output devices, such as LCD 1341, LEDs 1342, speaker 1343, and vibrated device 1344 in FIG. 3C. Applications can send the results to the proper output devices according to the users' profiles.

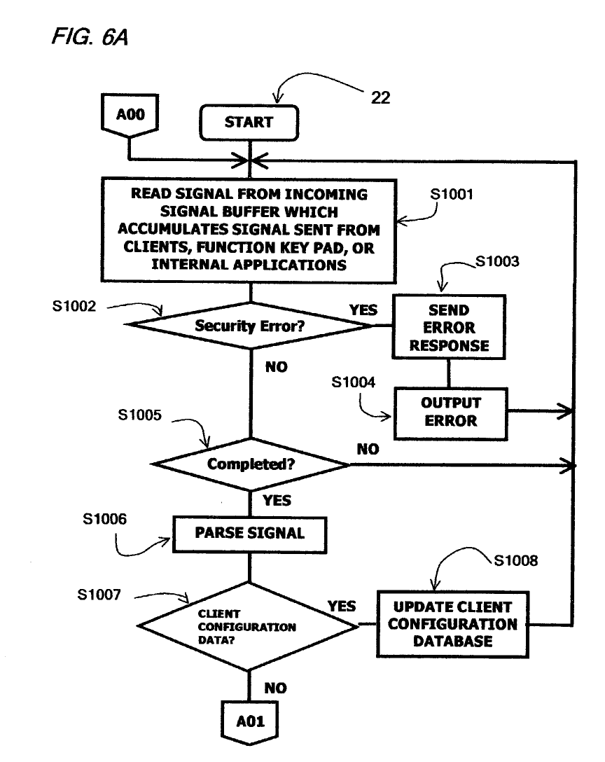

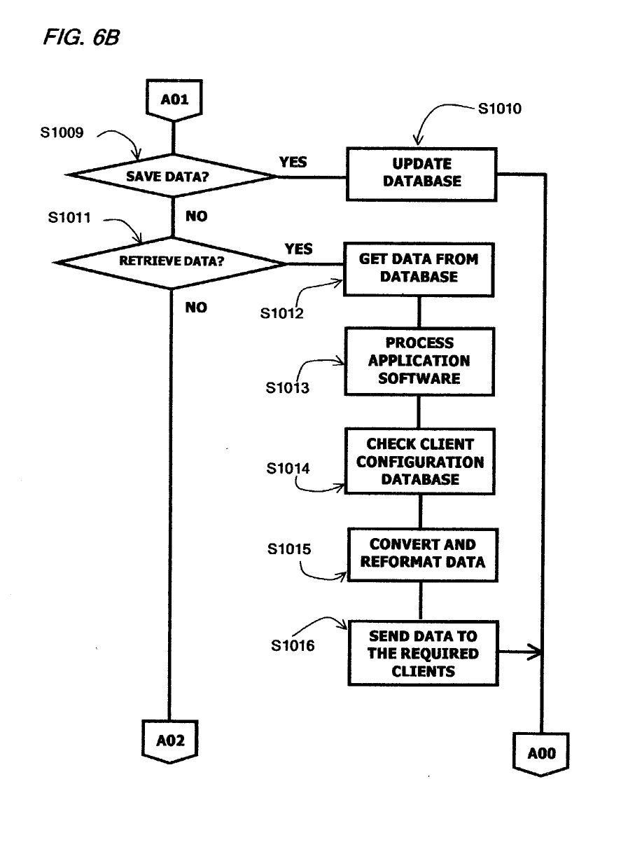

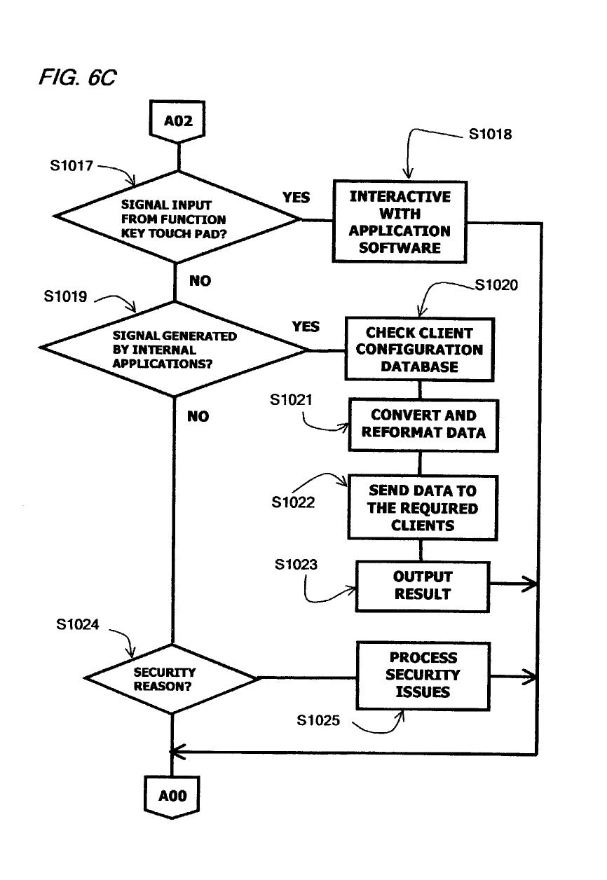

A message flow chat for the software portion 22 in the BWPNS denoted as 1 in FIG. 1B is illustrating in FIGS. 6A, 6B, and 6C. The processing at step S1001 is to read the incoming signal from the incoming signal buffer, which accumulates and stores all incoming signals. The incoming signal was possibly sent from personal communicators through a wireless or wire connection, or sent from the function keys denoted as 107, 108, and 109 in FIG. 2A by users' input, or sent from the internal (inside BWPNS) application. When the incoming signal is obtained, the security checking is needed to verify the cryptogrammic information that carried by the incoming signal. From the step S1002, if the incoming signal can not pass the security checking (has a security error), the step S1003 is performed to send out a failure response back to the sender, and the step S1004 is executed to output an error from the specific output devices, which were configured by user. If the incoming signal passed the security checking, the step S1005 is performed to assemble the fragmental signals if it is needed. If all fragmental signals for one message are not all received, the fragmental signals are stored in the buffer, and the processing is looping back to wait for the next fragmental signal. If one intact message is sent complete, the step S1006 is performed to parse the incoming signal. According to the signal type, the signal can be distinguished.

On step S1007, it checks if the incoming signal carries the client's (personal communicator's) configuration data, such as the screen size and resolution values of output screen on the mobile phone, the step S1008 is performed to update the client's profile, which will be used for the outgoing signal in order to send the correct format of the outgoing signal to fit the client's devices and requests.

The step S1009 is to check whether the incoming signal is for asking to store the data. If the signal is for asking to store the data, which is carried within the signal, the step S1010 will be called to update the proper database, which is according to what application is requesting for updating, such as email management application is asking for storing and updating the email database.

The step S1011 is to check whether the incoming signal is for asking to retrieve the data. If the signal is for asking to retrieve the data, the step S1012 is performed to get the proper data from the proper database, such as to get a text data from the text database. The next step S1013 is called to process application software for the necessary adjustment of the outgoing data, such as for a big outgoing data, the fragmentation processing is performed to send fragmental data one by one. Once the outgoing data is prepared, the step S1014 is performed to check the configuration database in order to get the receiver's resource profile, such as the receiver is a mobile phone and only can accept audio data. The step S1015 is called when the original outgoing data does not fit receiver's requests, therefore the original data needs to be converted and reformatted to fit the receiver's requests. For an instance, the text data needs to convert and reformat to become audio data to fit the receiver's (mobile phone) request. The step S1016 is performed to transmit the outgoing data to the output device, such as to send the outgoing data to the IEEE 802.11 protocol based wireless channel in order to send the data to the mobile phone.

Step S1017 checks whether the incoming signal is sent from the function key touch pad. If the incoming signal is from the function key touch pad, the step S1018 is performed to execute proper application to interactive with the input function keys. For an instance, the menu entry application program shows the menu on LCD. Its program asks the user to choose the proper item using the function keys 107, 108, or 109 in FIG. 2A.

Step S1020 is performed if the incoming signal has been checked through S1019 that the incoming signal was sent from the internal application, such as internal diagnostic management application. The step S1020 is performed for checking the configuration database in order to get the administrator's resource profile, such as the administrator is a mobile phone and only can accept audio data. The step S1021 is called when the original outgoing data does not fit administrator's requests, therefore the original data needs to be converted and reformatted to fit the administrator's requests. For an instance, the text data needs to be converted and reformatted to become audio data format to fit the administrator's (mobile phone) request. The step S1022 is performed to transmit the outgoing data to the output device, such as to send the outgoing data to the IEEE 802.11 protocol based wireless channel in order to send the data to the mobile phone. The step S1023 is performed to send out signal from the output devices sited in server, such as the diagnostic management detects the database storage problem, so it sends out the warning signal to the speaker device, which was configured as the default warning output device by user.

Step S1024 checks the in coming signal is for a security reason or not. If the signal is for a security reason, the step S1025 is performed to process the security issues, such as the incoming signal is for a security reason to try to erase all data in database, then the security process is performed to erase all data in database.

After all steps have been checked or performed, the processing loops back from the beginning to read the next signal from the incoming signal buffer.

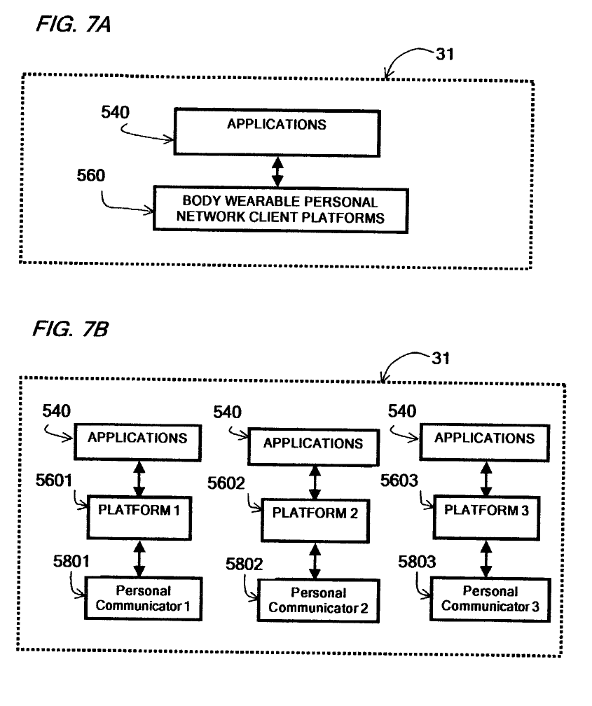

A block diagram FIG. 7A is illustrating the primary software units residing in Body Wearable Personal Network Client (BWPNC), personal communicator, and providing the capabilities to work with the BWPNS. The primary units include applications 540, and Body Wearable Personal Network Client Platform 560, which allows the identical applications 540 to port in the different BWPNS. The applications 540 in clients are the same of the applications that provide in server 201 through 212 in FIG. 4B.

FIG. 7B shows a concept of porting identical applications 540 to the different BWPNC based on the different platforms. One of the Body Wearable Personal Network Client Platforms 5601, 5602, or 5603 is only fit the particular one of personal communicators 5801, 5802, or 5803, but the identical applications 540 can suit with all Body Wearable Personal Network Client Platforms 5601, 5602, and 5603.

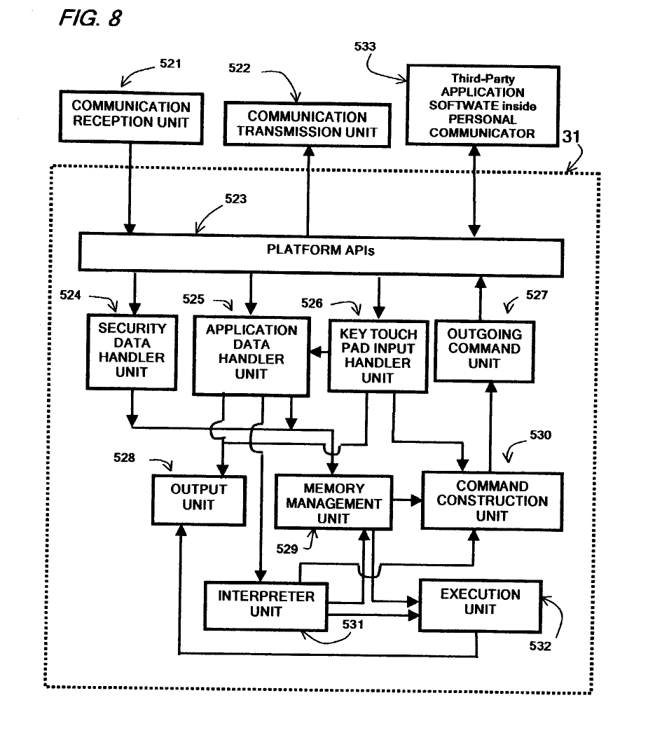

FIG. 8 is a data flow diagram illustrating the primary functionalities of the BWPNC. A pseudo closed space covers the software portion 31 in FIG. 1B in clients denoted as 2, 3, 4, and 5 in FIG. 1B. When the Communication Reception Unit 521 receives the incoming signal, it sends the signal to the proper signal handler unit though the platform APIs 523. The general signal handler units in the BWPNC include: Security Data Handler Unit in Client (SDHUC) 524: SDHUC is evoked when the incoming signal is sent for asking to handle security events.

Application Data Handler Unit in Client (ADHUC) 525: ADHUC is evoked when the incoming signal is sending to application tasks. ADHUC will execute the proper tasks to perform the request in the incoming signal, or to catch the data, which is sent with signal. Then ADHUC sends the data to the Memory Management Unit 529, or send the data to the Output Unit 528, or send the data to the Interpreter Unit 531. For an instance, one application in BWPNC sent out a command to BWPNS to ask for an old image data, the response signal with a request image data then is sent from the BWPNS to SDHUC and displays on the Output Unit in SDHUC.

Key Touch Pad Input Handler Unit in Client (KTPIHUC) 526: KTPIHUC is evoked when the input signal is sent from the key touch pad. KTPIHUC is interactively working with the key touch pad then asks applications to work for the requests, or sends requests to the Command Construction Unit 530 to construct a new command to BWPNS.

The Memory Management Unit 529 is for storing, and retrieving the temporary application data in RAM (Read Access Memory). The application data in the RAM maybe retrieved by the Execution Unit 532, which is one of the application programs to try to read the application data in order to perform the tasks according to the user's requests. The Command Construction Unit 530 may also retrieve the data from RAM, in order to build the new commands.

The Output Unit 528 interfaces to the device drivers, which provide from the Operating Systems of the personal communicators, such as Microsoft CE, and Symbian OS, in order to operate the output devices, such as LCD screen, and Speaker.

The Interpreter Unit 531 is evoked to interpreter the bytecodes, such as java programs, which are sent from BWPNS. The results of the binary codes are moved to the Execution Unit 532 for executing. The final results will send to the Output Unit 528.

The command Construction Unit 530 is evoked to build new commands. The new commands may be required to include parameters that can be retrieved from the RAM through Memory Management Unit 529.

The Outgoing Command Unit (OCU) 527 is evoked when any commands and data need to be sent out by the Communication Transmission Unit 522 via the function calls from platform APIs. The OCU 527 will check the size of the data in the outgoing data, if the size is too large, the fragmentation function will be performed to send out consecutive fragmental data.

If some of applications, which are provided by other entities (other software provides supports the software was not originally for communicating with BWPNS), want to communicate with BWPNS. These applications are able to communicate with BWPNS through platform APIs 523.

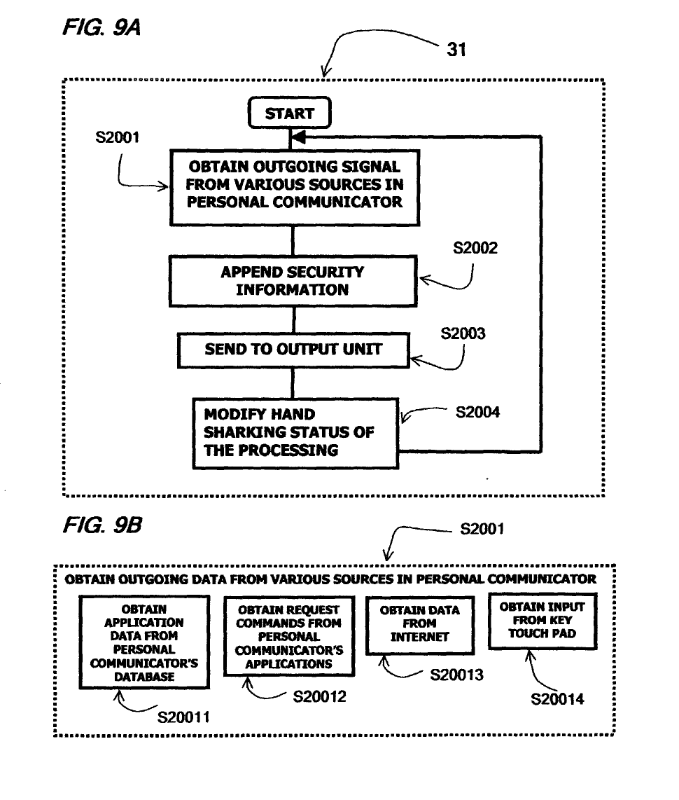

Message flow chats FIGS. 9A and 9B illustrate the outgoing signal processing in the software portion 31 in FIG. 1B in BWPNC. The step S2001 is performed when the BWPNC (a personal communicator) obtains the outgoing signal and data from the personal communicator's database (step S20011), or from the request commands from the personal communicator's applications (step S20012), or from Internet WEB Server (step S20013), or from the input of key touch pad (step S20012). After step S2001 , the outgoing message is successfully received, and is kept in the temporary buffer. The step S2002 then is performed to append the security data into the outgoing message based on the security information stored in the security database. The step S2003 is performed to transmit the outgoing message to the output unit. After step S2003, the hand sharking status between server and client needs to be updated to indicate that the message has been sent from BWPNC to BWPNS (step S2004).

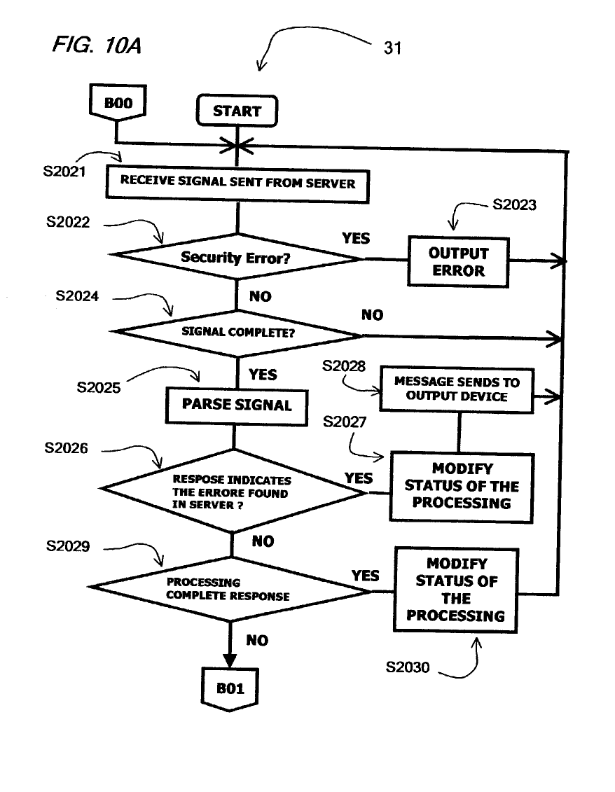

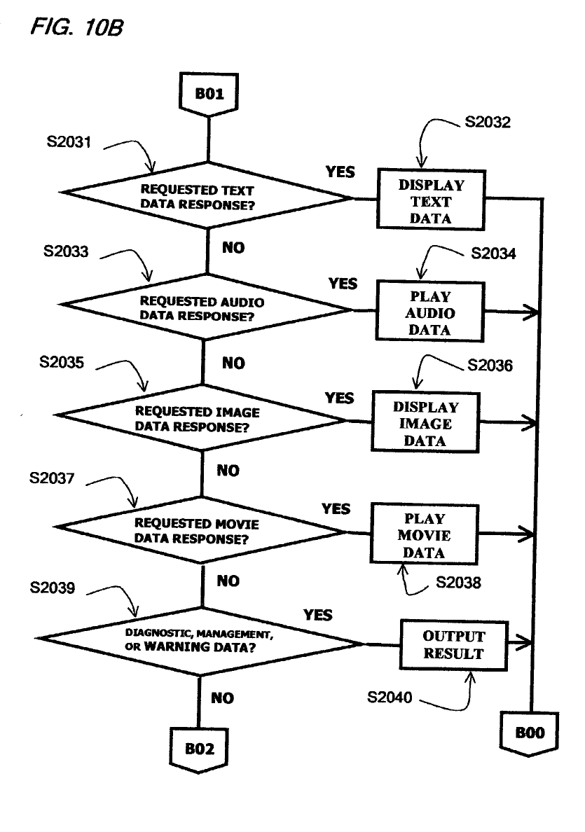

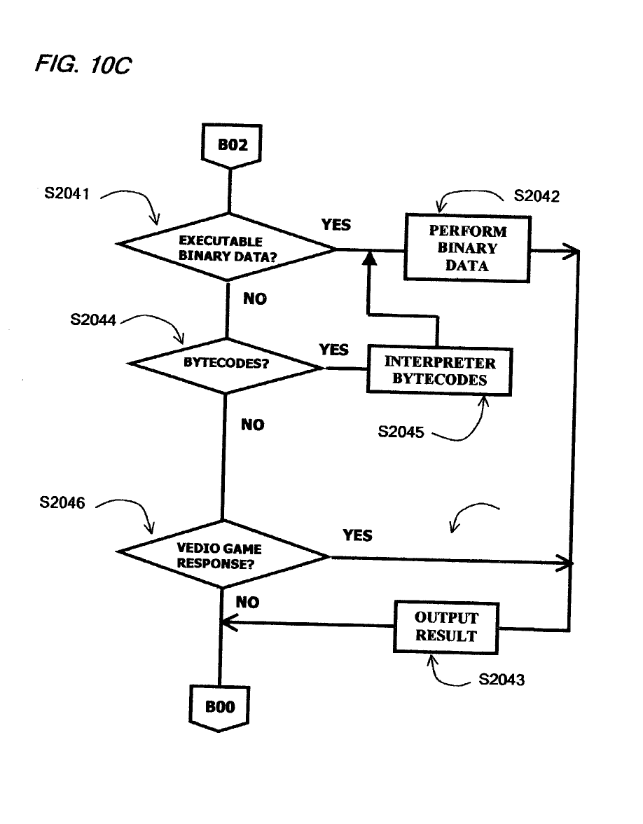

A message flow chat FIGS. 10A, 10B, and 10C illustrates the incoming signal processing in the software portion 31 in FIG. 1B in BWPNC. The processing is triggered when the incoming signal sent from BWPNS is received from the signal buffer (step S2021). When the incoming signal is obtained, the security checking is needed to verify the cryptogrammic information that carried by the incoming signal. From the step S2022, if the incoming signal is unable to pass the security checking (has a security error), the step S2023 is performed to send out a failure message to the Output Unit. If the incoming signal passed the security checking, the stepS2024 is performed to assemble the fragmental signals. If all fragmental signals for one message are not all received, the fragmental signals are stored in the buffer, and the processing is looping back to wait for the next fragmental signal. If one intact message is received complete, the step S2025 is performed to parse the incoming signal. According to the signal type, the signal can be distinguished.

On step S2026, it checks if the incoming signal is the response signal with an error indicator, which indicates the error was found in BWPNS during the processing, the step S2027 is performed to modify the hand sharking status to express that the response is sent back. The step S2028 is called to send the error indication to the output unit.

If the processing is complete (step S2029), the step S2030 is performed to modify the hand sharking status to express that the response is sent back.

If the text data is response as the request (step S2031), the step S2032 is performed to display the text data.

If the audio data is response as the request (step S2033), the step S2034 is performed to play the audio data.

If the image data is response as the request (step S2035), the step S2036 is performed to display the image data.

If the movie data is response as the request (step S2037), the step S2038 is performed to play the movie data.

If the diagnostic, warning, or management signal is response as the request (step S2039), the step S2040 is performed to send the response to the proper output unit.

If the executable binary data is response as the request (step S2041), the step S2042 is performed to execute the binary data, and then the step S2043 is called to output the results.

If the bytecodes are response as the request (step S2044), the step S2045 is performed to interpreter the bytecodes to the binary codes, and the step S2042 is performed to execute the binary codes, and then the step S2043 is called to output the results.

If the video game data is response as the request (step S2046), the step S2043 is called to output the results.

After all checking, the processing is looping back from the beginning to wait or execute the next signal.

Second Embodiment

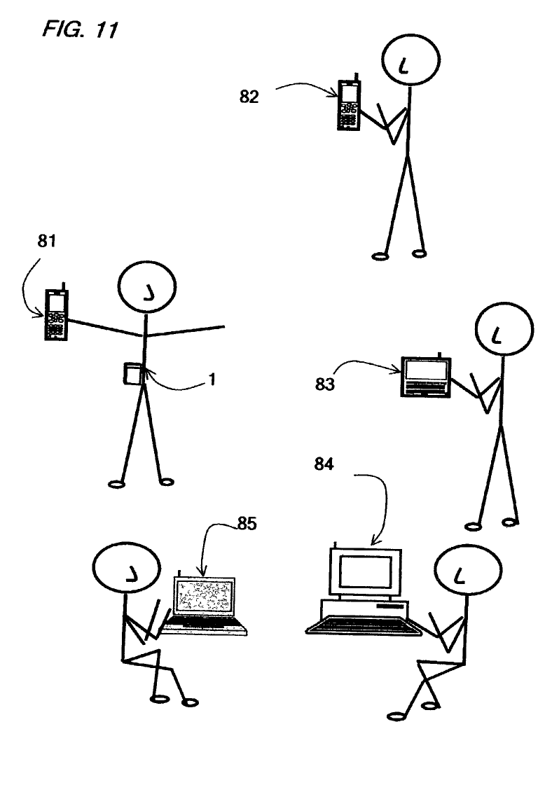

FIG. 11 generally illustrates the second usage of BWPNS and BWPNC. The BWPNS can be configured for multiple users. The clients denoted as 81, 82, 83, 84, and 85 are allowed to access BWPNS simultaneously. All software and hardware portions of the new configuration are the identical as the first embodiment.

What is claimed is:

1. A body wearable personal network server and system comprising:
an operating management unit to provide server capability in the server-client model; one communication unit for communicating the clients in PAN; one wireless communication unit to receive and transmit data from and to the WLAN and having communication circuitry for the wireless transmission; at least one client, which includes application software to interactive with the server; a security unit to identify and authorize each client.

2. The server and system according to claim 1, within an operating management unit is an operating system, with internet protocols, and providing application and database service capabilities.

3. The server and system according to claim 2, within an operating system, which is the software includes the lower-level software routines that directly control the hardware. The key components of the operating system contains:
a). The memory manager dynamically obtains and releases memory for applications and the operation system. An application's procedural code also occupies space in the heap.
b). The segment loader loads programs to be executed. An application can be loaded all at once, or it can be parceled into separate segments that are loaded dynamically as needed.
c). The file manager supports file input/output; the device manager supports device input/out.
d). Device drivers are programs that enable the various types of devices to present uniform input/output interfaces to applications. The device drivers are built in to the operating system in ROM are disk driver manages the accessing of information on disks; power device controls the power and reports the power strength to the applications; The PC card device driver to handle data sends and receives through the PC card, which includes a build-in antenna; wire communication device sends and receives data through the USB wire port; display driver exhibits the text or objects on the screen; function key drivers receive the input from the function key touch pad.
e). The schedule manager schedules activities to be performed during the interrupts.
f). The system error handler gets control when the fatal system error occurs.
g). The operating system utilities provide a variety of useful functions including obtaining the date and the time.

4. The server and system according to claim 2, within internet protocols are IEEE 802.11, Bluetooth, or serial type of physical and data link layers, IP, TCP, and HTTP, XML, and FTP protocols.

5. The server and system according to claim 2, within application and database service capabilities are an XML application and database server. Under the XML server, each client is treated as a presentation device. The XML server takes care of all the device detection and makes XML requests of the content server. The database sends up XML content that the presentation tier can reformat for each device.

6. The server and system according to claim 2, within a specific application is configured for all users is a video game. The BWPNS can be configured as the game box for multiple players.

7. The server and system according to claim 1, within one communication unit for communicating the clients in PAN, and one wireless communication unit to receive and transmit data from and to the WLAN. Both of these two communication units can be designed in wireless type of communication units, and can be built together in the BWPNS.

8. The server and system according to claim 1, within one communication unit for communicating the clients in PAN, and one wireless communication unit to receive and transmit data from and to the WLAN. Both of these two communication units can be designed in wireless type of communication units, and can be built in one PCMCIA card or one PCI card; Blue802 technology is adopted, which combines Bluetooth and IEEE802.11b chipsets in one PCMCIA or PCI card.

9. The server and system according to claim 1, within one communication unit for communicating the clients in PAN is an USB type of connection port.

10. The server and system according to claim 1, within at least one client is a mobile phone, personal digital assistant (PDA), notebook computer, packet personal computer, or personal computer, which provides application software and communication port to communicate with server.

11. The server and system according to claim 1, within a security unit to identify and authorize each client is to assign a unique identification for each client, and to configure a security profile for each client.

12. A body wearable personal network server and system comprising:
an operating management unit to provide server capability in the server-client model; one communication unit for communicating the clients in PAN; one wireless communication unit to receive and transmit data from and to the WLAN and having communication circuitry for the wireless transmission; a data formatting unit to convert data to the proper format of data based on the client's profile; at least one client, which includes application software to interactive with the service; a security unit to identify and authorize each client.

13. The driver according to claim 12, within a data formatting unit is an application routine to provide receiving and transmitting from and to text, audio, CD audio track, MIDI, movie, video, windows media, and binary format of data, also to convert text data to voice data and vice visa.

14. A body wearable personal network server device comprising:
a display configured to display at least time information; function key button circuitry; one communication unit for communicating the clients in PAN; one wireless communication unit to receive and transmit data from and to the WLAN and having communication circuitry for the wireless transmission; a CMOS memory to retain information about the body wearable personal network server device; at least one Random Access Memory (RAM) device; a power supply device; a microprocessor for controlling the display, receiving entering data through function key buttons, accessing memory devices, and handling the communication circuit.

15. The device according to claim 14, within at least one RAM device is RAM memory chips or a hard disk drive, or both.

16. The device according to claim 14, within a power supply device is a rechargeable battery.

17. The device according to claim 16, within a rechargeable battery is a programmable battery device and the battery strength can be read by program.

18. The driver according to claim 14, within one communication circuit is a wireless communication circuit.

19. The driver according to claim 14, within one communication circuit is a wireless communication circuit, and a wire communication circuit can be provided.

20. A body wearable personal network server device comprising:
a display configured to display at least time information; function key button circuitry; one communication unit for communicating the clients in PAN; one wireless communication unit to receive and transmit data from and to the WLAN and having communication circuitry for the wireless transmission; a CMOS memory to retain information about the body wearable personal network server device; at least one Random Access Memory (RAM) device; a power supply device; at least one output warning signal device to indicate the exception situation to the user; a microprocessor for controlling the display, receiving entering data through function key buttons, accessing memory devices, and handling the communication circuit.

21. The device according to claim 20, within at least one output warning signal device to indicate the exception situation to the user is a built-in speaker to provide basic sound capabilities.

22. The device according to claim 20, within at least one output warning signal device to indicate the exception situation to the user is a vibrated device.

23. The device according to claim 20, within at least one output warning signal device to indicate the exception situation to the user is LED (Light Emitting Diode) devices, which are programmable.

24. The device according to claim 23, within the programmable LED devices, which can be changed to different colors or flash.

25. The device according to claim 20, within at least one output warning signal device to indicate the exception situation to the user is to design to add more than one output devices, which are a built-in speaker, a vibrated device, and LED devices.

26. The device according to claim 20, further comprising a memory card driver, or a CD RAM device, or a hard disk device.

27. A body wearable personal network server and system comprising:
an operating management unit to provide server capability in the server-client model; one communication unit for communicating the clients in PAN; one wireless communication unit to receive and transmit data from and to the WLAN and having communication circuitry for the wireless transmission; more than one clients are configured, which includes application software to interactive with the service; a security unit to identify and authorize each client.

28. A body wearable personal network server and system comprising:
an operating management unit to provide server capability in the server-client model; one communication unit for communicating the clients in PAN; one wireless communication unit to receive and transmit data from and to the WLAN and having communication circuitry for the wireless transmission; more than one clients are configured, which includes application software to interactive with the service; a security unit to identify and authorize each client; a specific application is configured for all users.

29. A body wearable personal network server and system comprising:
an operating management unit to provide server capability in the server-client model; one communication unit for communicating the clients in PAN; one wireless communication unit to receive and transmit data from and to the WLAN and having communication circuitry for the wireless transmission; more than one clients are configured, which includes application software to interactive with the service; a security unit to identify and authorize each client; a specific application is configured for all users.

30. A body wearable personal network server and system comprising:
an operating management unit to provide server capability in the server-client model; one communication unit for communicating the clients in PAN; at least one client, which includes application software to interactive with the server; a security unit to identify and authorize each client.

31. The server and system according to claim 30, within one communication unit for communicating the clients in PAN. This communication unit can be a wireless type of communication unit, or a USB type of wire communication port.
